(19) United States
(12) Patent Application Publication
(10) Pub. No.: US 2003/0195857 A1
(43) Pub. Date: Oct. 16, 2003

(54) Communication technique to verify and send information anonymously among many parties

(75) Inventor: Alessandro Acquisti, Oakland, CA (US)

Correspondence Address: Alessandro Acquisti, 5586 Taft Av., Oakland, CA, 94618, US

(73) Assignee: Alessandro Acquisti, Oakland, CA (US)

(21) Appl. No.: 10/408,593

(22) Filed: Apr. 7, 2003

Related U.S. Application Data
(60) Provisional application No. 60/370,991, filed on Apr. 10, 2002.

(51) Int. Cl. G06F 17/60

(52) U.S. Cl. 705/74

(57) ABSTRACT

A communication networking technique is presented that allows sending parties to send information to receiving parties through a third party, in such a way that said third party determines whether a sending party is “eligible” to send information to receiving parties and whether the information to be sent is “valid,” and the receiving parties can determine whether the sender has been deemed eligible and the information has been deemed valid, but no receiving party and no third party is able to associate a specific eligible sender to specific valid information. The information can be associated to several types of transactions: it can encapsulate payment information when the technique is used in financial transactions; it can encapsulate expressions of interest or vote when the technique is used in election and recommendation systems; it can encapsulate information that individuals want to share, when the technique is used in file-sharing systems.

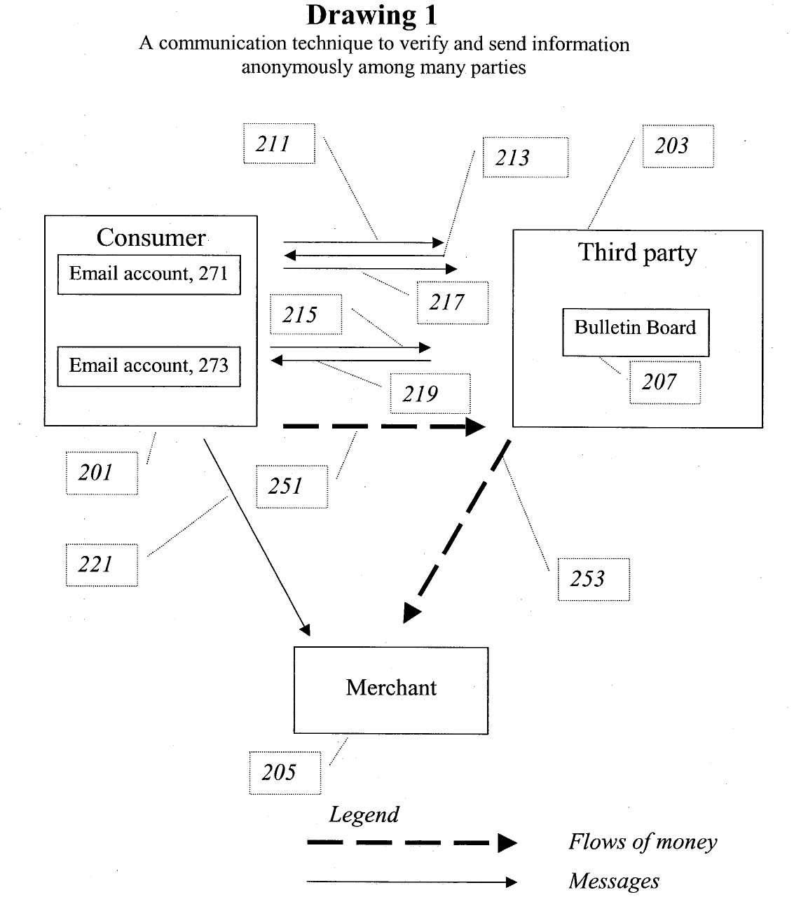

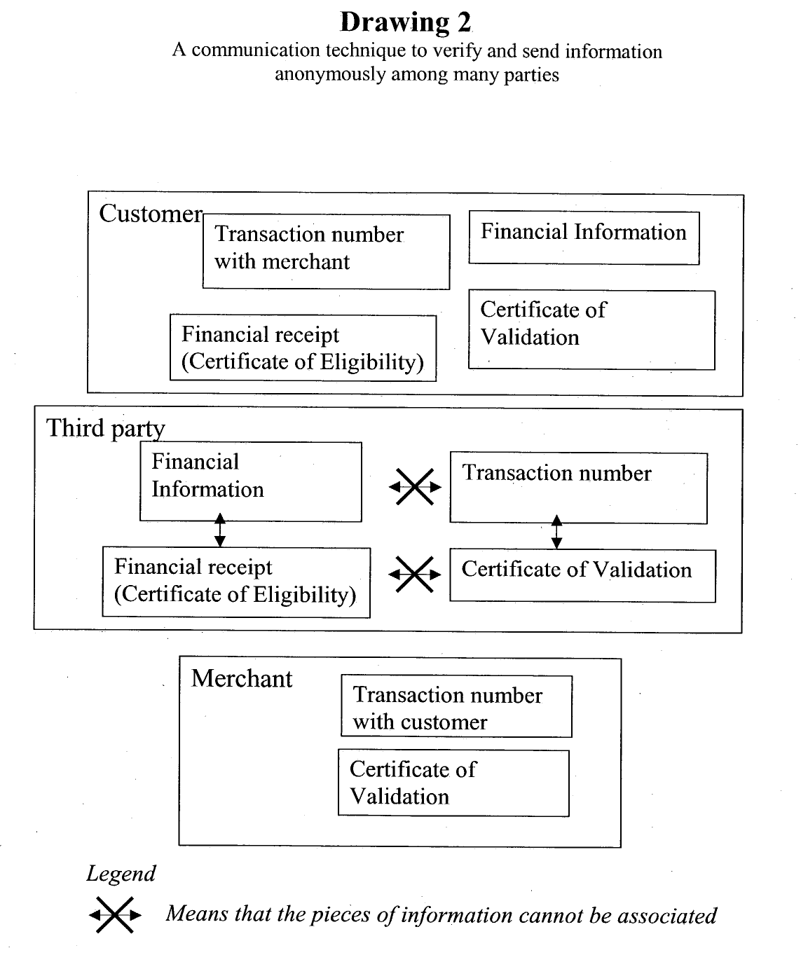

### CROSS-REFERENCES TO RELATED APPLICATIONS

This application claims priority from U.S. Provisional Patent Application No. 60/370,991 filed Apr. 10, 2002, commonly assigned and hereby incorporated by reference for all purposes.

### STATEMENT AS TO RIGHTS TO INVENTIONS MADE UNDER FEDERALLY SPONSORED RESEARCH OR DEVELOPMENT

NOT APPLICABLE

### REFERENCE TO A “SEQUENCE LISTING,” A TABLE, OR A COMPUTER PROGRAM LISTING APPENDIX SUBMITTED ON A COMPACT DISK

NOT APPLICABLE

### BACKGROUND OF THE INVENTION

The present invention relates generally to communication techniques. More particularly, the invention provides a method and system for allowing sending parties to send information to receiving parties through a third party, in such a way that said third party determines whether a sending party is “eligible” to send information to receiving parties and whether the information to be sent is “valid,” according to criteria set by the third party. A sending party deemed eligible is associated to a “certificate of eligibility” and the information deemed valid is associated to a “certificate of validity.” A party receiving information through this method can verify that the information has been deemed valid by the third party and can conclude that the sender of the information has been deemed eligible. Preferably, the communication is anonymous, in the sense that neither the third party nor any of the receiving parties are able to recognize any correspondence between a certificate of eligibility associated to a sending party and a certificate of validity associated to the information sent by that sending party. Merely by way of example, the present invention is applied to a wide area network environment such as the Internet. But it would be recognized that the invention can be applied to other networks such as local area networks, enterprise networks, physical networks, wireless networks (e.g., local and cellular), any combination of these and the like.

Communication techniques have been known. Techniques for communicating through electronic networks have also been known. As merely an example, such networks include, among others, telephone, and wide area networking techniques such as those on the Internet. Electronic mail is an example of such networking techniques, but there are many others. In particular, there are techniques for anonymous communications. For instance, David Chaum et al. (U.S. Pat. No. 5,956,400) have proposed to use portioned storage devices that store separately related sensitive medical information, and to delegate to a “mapper” the control of the retrieval of related information from the various partitions. However, this system relies on trusted party (the “mapper”) and is not applicable to payment systems or other systems. In another example, David Chaum (“Untraceable Electronic Mail, Return Addresses, and Digital Pseudonyms,” Communications of the ACM, 24 [2], 1981) introduced the notion of a “mix”—a system operated by a third party that allows for a sender of a message in an electronic mail systems to remain unknown to the receiver. However, the mix must be a trusted party. In the case of individuals using wide area network environments such as the Internet to access remote computers, M. K. Reiter and A. D. Rubin (“Anonymous Web Transactions with Crowds”. Communications of the ACM, 42(2), pp. 32-38, 1999) have proposed a system for protecting the anonymity of the individuals by hiding their activities inside a “crowd” of many other participants. While the risk of collusion in these kinds of systems is lower, these systems are limited in use since they only can be used to redirect messages from remote computers without requiring the verification of the content of those messages. There are other examples in other publications and some of these examples refer to anonymous forms of payment. N. F. Maxemchuk and S. H. Low (U.S. Pat. No. 5,420,926; and, “The Use of Communication Networks to Increase Personal Privacy In a Health Insurance Architecture”, AT&T Labs-Research Murray Hill, N.J. 07974) have proposed a “double-locked boxes” structure so that parties of a financial transaction identify people through pseudonyms, and a match between a person's identity and its purchases can be only done by the person himself (or through collusion of many of the interested parties). The structure proposed however requires the person to hold accounts in different bank. Such banks must generally coordinate each with the other to make the payment anonymous. However, by colluding with the other parties of the transaction, they can also violate the anonymity of the transaction. In other examples, David Chaum proposes “blind signature systems” (U.S. Pat. Nos. 4,759,063, 4,759,064, 4,914,698, 4,947,430, 4,949,380, 4,987,593) where the sender of a message can transform such message before passing it to a signing entity, that signs it digitally and then returns the signed message to the sender, who can in turn transform back the signed message in a way that a digital signature related to each original message is developed by the sender, but without letting the signing entity know which transformed message the sender received corresponds with which digital signature. However, the blind signature systems require the sender to use a particular machine or application in order to do the transformation, and, in the case of the system being used for payments, they also require the sender to open a financial account with the signing entity, thus making the use of such systems more complicated to the sender than other traditional payment systems, such as credit cards. In other applications, the user of the anonymous communication or payment system often needs to possess some kind of physical device whenever he/she wants to complete a transaction (see U.S. Pat. No. 5,511,121)], which makes their usage cumbersome. In more recent Patent Applications (U.S. Patent Application No. 20010049655, 20020026418 , 20020046341) others have proposed anonymous credit card systems. These applications however either refer to systems based on a trusted third party that manages some form of pre-paid credit card account, or they require the purchaser using the system to complete the purchase in multi steps (such as purchasing the card in a physical store, authorizing it at a sponsor's site, and then using it on the Internet or elsewhere), which makes their usage again cumbersome. Acquisti (provisional patent application 60/256,045, Filed Dec. 18, 2000, and U.S. patent application Ser. No. 10/024,653, filed Dec. 17, 2001), the inventor of this current patent application, also discusses a network communication technique for anonymous payments between generic parties using multiple methods of payment. While this latter technique is not exposed to the risk of collusion, its area of application is focused on financial transactions.

So, although some of these techniques had some success, there are evidently many limitations in their usage. From the above, it is seen that an improved communication technique between many parties is highly desirable.

### BRIEF SUMMARY OF THE INVENTION

According to the present invention, techniques for improved communications over networks are provided. More particularly, the invention provides a method and system for allowing sending parties to send information to receiving parties through a third party, in such a way that said third party determines whether a sending party is “eligible” to send information to receiving parties and whether the information to be sent is “valid,” according to criteria set by the third party. A sending party deemed eligible is associated to a “certificate of eligibility” and the information deemed valid is associated to a “certificate of validity.” A party receiving information through this method can verify that the information has been deemed valid by the third party and can conclude that the sender of the information has been deemed eligible. Preferably, the communication is anonymous, in the sense that neither the third party nor any of the receiving parties are able to recognize any correspondence between a certificate of eligibility associated to a sending party and a certificate of validity associated to the information sent by that sending party. Merely by way of example, the present invention is applied to a wide area network environment such as the Internet. But it would be recognized that the invention can be applied to other networks such as local area networks, enterprise networks, physical networks, wireless networks (e.g., local and cellular), any combination of these and the like.

In this invention, the “information” can be related to several types of transactions: it can encapsulate payment information when the invention is used in financial transactions; it can encapsulate expressions of interest or vote when the invention is used in election and recommendation systems; it can encapsulate information that individuals want to share, when the method is used in file-sharing systems. The “third party” is a party able to receive messages from a sending party and judge whether each sending party is “eligible” to send information to other receiving parties and whether the information is “valid” to be sent to other receiving parties. An “eligible” party is a party that satisfies any criteria that the third party has set in order to grant such party a “certificate of eligibility.” A “certificate of eligibility” provides evidence to other parties that the sending party has been deemed eligible. For example, in an election, a certificate of eligibility would be granted by the third party election authority to a party that is authorized to vote in that election. “Valid” information is information that satisfies any criteria that the third party has set in order to grant such information a “certificate of validity.” A “certificate of validity” for a certain piece of information provides evidence to other parties that the piece of information associated to that certificate has been deemed valid to be sent. For example, in an election, a certificate of validity would be granted by the third party election authority to a piece of information representing a vote cast by an eligible voter. “Anonymously” means that another party (such as the receiving party) can verify the eligibility of the sender to send certain information and the validity of the information that was sent, but neither the third party nor the receiving party nor any other party is able to associate a specific certificate of eligibility to a specific certificate of validation. That means that no party can associate the eligible sender of certain information with the certificate of validation for that information. Therefore, unlike known techniques for anonymous communications, the technique does not need to rely on a “trusted” third party, that is, on a third party that must be trusted not to reveal certain information, because not even the third party is able to associate an eligible sender with the certificate of validation of the information that sender is sending. In addition, unlike known techniques, this technique allows the third party to verify the information before validating it, in addition to verifying that the sender of the information is eligible to send information. The novel combination of these two features allows this invention to be used in a vast variety of applications, such as anonymous payments, electronic voting, anonymous messaging, anonymous file sharing, and others. This invention therefore has several advantages and numerous features. As merely an example, the advantages of this techniques are that the anonymity of the sending parties is preserved under very general conditions, included the collusion between most of the other parties. Another advantage is that the protocol can be used in several different scenarios. Another advantage is that while the communication is anonymous in the sense described above, the information being sent through the method can be verified.

Depending upon the embodiment, there may be one or more of these features in any of the embodiments described herein. The exemplary embodiments of this invention disclosed below allow for anonymous communication regardless of the communication channel or medium and the nature of the parties being involved in the communication. The exemplary embodiments of this invention disclosed below are just some of the many possible embodiments. It is evident therefore to those with ordinary skills in the art that the method is flexible and can be used in such areas as voting systems, payment systems, and many others. In case of financial transactions, for example, the certificate of eligibility will be a proof of a transfer of funds or money from the sending party to the third party, and the certificate of validation will be a token representing the amount of money that the sending party can now transfer to the receiving party, where the receiving party will be able to receive finds or money in exchange of services provided to the sending party, whose financial information he does not know, by presenting back to the third party the token representing the certificate of validation received from the sending party. In the case of an election, the certificate of eligibility will be created as the third party verifies the sending party's personal information and identity so to check that the sending party can participate and vote in the election, and the certificate of validation will be a token that the sending party will present to the authority administrating the election, in order to place his vote without such authority being able to verify his personal information but being sure that the sending party is eligible for that election.

Various additional objects, features and advantages of the present invention can be more fully appreciated with reference to the detailed description and accompanying drawings that follow.

### BRIEF DESCRIPTION OF THE DRAWINGS

Drawing 1 is a simplified system flow diagram according to an exemplary Embodiment One, where a customer from his computer 201 is purchasing a good or service from a merchant computer 205 through a third party computer 203. The Drawing shows flows of messages and money. Other customers are also purchasing from other merchant computer through the third party computer, but their flows of messages and money are not reported in the Drawing.

Drawing 2 is a simplified entity/relationship diagram according to an exemplary Embodiment One of the present invention. The Drawing shows the various pieces of information that the various parties of the technique can observe and store.

### DETAILED DESCRIPTION OF THE INVENTION

According to the present invention, techniques for improved communications over networks are provided. More particularly, the invention provides a method and system for allowing sending parties to send information to receiving parties through a third party, in such a way that said third party determines whether a sending party is “eligible” to send information to receiving parties and whether the information to be sent is “valid,” according to criteria set by the third party. A sending party deemed eligible is associated to a “certificate of eligibility” and the information deemed valid is associated to a “certificate of validity.” A party receiving information through this method can verify that the information has been deemed valid by the third party and can conclude that the sender of the information has been deemed eligible. Merely by way of example, the present invention is applied to a wide area network environment such as the Internet. But it would be recognized that the invention can be applied to other networks such as local area networks, enterprise networks, physical networks, wireless networks (e.g., local and cellular), any combination of these and the like. Additionally, the invention can be applied to other forms of transactions such as information flow, other forms of economic transactions, anonymous information flow, voting, file sharing, and the like. The invention can be applied to industries such as financial transactions, gaming, entertainment, information sharing, file distributions, customized services for high-net worth individuals, electronic voting, electronic trading, and the like.

Exemplary Embodiment Zero

A set of sending parties exists, numbered 1 to N, and a set of receiving parties, numbered 1 to M. The following steps compose the process:

1. Each sending party transfers a first message, 1, to a third party. Message 1 contains some objects, in particular information that the third party needs to know to determine the eligibility of the sending party to transfer some information in a message to one or many of the receiving parties (for example, the real identity or proof of age of the sender). In this embodiment, “eligibility” means that the sending party can give evidence to the third party that it meets some criteria set by the third party in order to be deemed eligible. In a voting system application, eligibility may be related the age of the sending party; in a payment application, it may be related to a financial account owned by the sending party. Message 1 also contains another object, which represents some form of “return information” that the third party needs in order for its reply to arrive to the sending party (for example, a return postal address).

2. The third party determines the eligibility of each sending party. Then, for each sending party that is deemed eligible, the third party sends a second message, 2, using the return information included in message 1. Each message 2 contains a unique certificate of eligibility. This certificate is associated to the return information included in message 1, in the sense that other parties would be able to recognize that a certain certificate of eligibility has been created for a certain return information from the two pieces of information alone (for example, the certificate of eligibility could be a written statement by the third party specifically addressed to the return address sending party).

3. The N sending parties send each a third message, 3, to the third party. Each message 3 contains the actual message that includes the information that each sending party wants to transfer to the receiving party (or parties), and an unique identifier for that message. Each message 3 also contains a “new” return information that allows the third party to contact the sender of each message 3. “New” means that for each sending party the return information contained in message 3 is different from the return information contained in message 1. The two return addresses have no association. Hence neither the third party nor any other party (excluded the sending party itself) is able to associate message 1 and message 3 sent from the same sending party using the return address information alone. For example, message 1 and message 3 could be two physical letters posted from different geographical locations and reporting different return addresses, so that the receiver, using the return address information alone, would not be able to know that they have been sent by the same party.

4. The third party compiles a list of the T of the N messages 3 whose included information the third party deems to be “valid” (where it may be: T less or equal to N), and associates each of them to one single unique identifier created for the list. The third party judges what information can be deemed valid. Thereafter, the third party sends to all N parties who sent messages 1 a fourth message, 4, using the return information contained in message 1. The fourth message is the same for every sending party and contains the unique identifiers for T messages containing information that have been deemed valid, as well as the unique identifier that the third party has selected for that list.

5. All N parties receive the same message 4, but only T of them find that the unique identifier associated to their message 3 is contained in the list. Those T sending parties now know that the information included in their message 3 has been deemed valid, and they reply to the third party by sending each a fifth message, 5. Each message 5 contains for each sending party the unique certificate of eligibility that that sending party had received from the third party with message 2. Each message 5 also contains the unique identifier for the list sent by the third party with message 4. However, each message 5 does not contain any reference to message 3. This means that upon receiving T instances of message 5, the third party will not be able to link the sender of each message 5 to the sender of each message 3. Hence the third party cannot associate the certificate of eligibility to the validated final information contained in message 3 that each sending party wants to transfer to the receiving party.

6. The third party, upon receiving exactly T message 5, each containing a unique certificate of eligibility and the unique identifier for the list, creates T certificate of validation for the information in the T selected messages. A certificate of validation is a message that shows that the information contained in each message 3 has been deemed “valid” by the third party. Each certificate of validation is unique and is not repeated for any other sending party, and is of course associated to the third message in a way that every other party could recognize that a certain certificate of validation has been created for the information in a certain third message or the information it includes (for example, in an application based on cryptography, each certificate of validation might contain an hash of message 3). The third party then sends the unique certificates of validation to the T parties in T sixth messages, 6. Importantly, the third party uses the return information contained in each of the T selected third messages, rather than the return information associated to messages 1 or 5. Importantly, the third party waited to receive T messages 5 before creating the certificates of validity for the information it had deemed valid.

7. Upon reception of the certificates of validation, each sending party can now create the seventh and final message to be sent “anonymously” to the final recipient. Each seventh message contains the information originally contained in the third message, and the associated certificates of validation. “Anonymously” means that the party receiving the message will know that the sending party of that message is an eligible sender and that the information is validated. However, the recipient will be unable to link a specific certificate of validation to a specific certificate of eligibility. So, for example, in a payment application the merchant might receive a message containing payment tokens (the “validated” information), but will be unable to link them to the credit card information that the sender passed to the third party in order to receive the tokens (the “eligibility” certificate). In a voting application, the electoral authority receiving a certain valid voting token (the validated “information”) will be unable to link it to the legal identity of the voter (whose eligibility to vote will have been verified in message 1). In an anonymous messaging application, each sender might receive a list of recipients in message 1, and an encrypted message in message 3, so that it would forward the encrypted messages to entire sets of selected recipients with only the designated recipient being able to decrypt the message, but nobody else being able to link a specific message to a specific recipient.

Exemplary Embodiment One

Drawing 1 and Drawing 2 show an exemplary Embodiment One for the invention, referring to its use in an online shopping (ecommerce) application. Those with ordinary skills in the art will understand that different forms and versions are possible and easily derived while remaining within the scope and spirit of the present invention.

Drawing 1 is a simplified system flow diagram according to an exemplary Embodiment One, where a customer from his computer 201 is purchasing a good or service from a merchant computer 205 through a third party computer 203. The Drawing shows flows of messages and money. Other customers are also purchasing from other merchant computers through the third party computer, but their flows of messages and money are not reported in the Drawing.

Each sending party is a customer who is using a computer to send money anonymously to a receiving party that is a merchant computer. Anonymously means that the sending party does not want anybody to be able to associate his identity to the specific transaction concluded with the merchant computer, and yet he also wants the merchant computer to conclude the transaction with him on the basis of a transferal of money that takes place through a third party computer.

The customer from his computer (201), which is 1 of N sending parties computers attached through a wide area network such as the Internet or a LAN (local area network) to the third party computer (203), sends his financial information (message 211. Many messages similar to 211 are sent from the N sending parties to the third party computer, but only one is reported in the drawing) to the third party computer (the financial information may be sent by email, using a first email account address 271; but other solutions are possible). The financial information may contain the credit card number and name of the customer and the amount that the customer wants the third party computer to charge on that credit card.

The third party computer uses the financial information of the customer to charge the customer's credit card (flow of money 251), thereby transferring funds from the customer to himself. In exchange for that, the third party computer assigns a “certificate of eligibility” to the sending party in the form of a financial receipt that the third party writes for the sending party and sends to the sending party's computer (message 213). The financial receipt contains information about the amount that has been charged on the credit card of the customer, but contains no other information about the financial information of the customer. The financial receipt testifies that the owner of the receipt has a credit towards the third party computer. The third party computer sends similar messages 213 to all N customers that sent a message 211. However, these additional messages are not reported in the Drawing.

The customer computer receives the financial receipt and sends another message (message 215) to the third party computer that contains transaction information about the transaction that the customer wants to conclude with one merchant computer 205, which is 1 of M receiving parties in the network. Importantly, the customer computer sends message 215 from a different location and with a different return address. In particular, the message may be sent from a second, different email account address, 273 (or it may be sent by having the customer log into the third party computer with a different account name, or broadcast the message by radio signal on a LAN network; other solutions are also possible). Hence the third party computer is not able to recognize that this and the previous messages sent by the customer are originated from the same computer. The information that the customer sends may contain a transaction number that the customer wants to use as reference for the transaction he wants to complete with the merchant computer, and other information needed to complete the transaction such as the price of the good or service that the customer wants to acquire from the merchant computer, and the contact details and financial information of the merchant computer (for example, details about the method the merchant computer uses to be paid). All N customers send similar messages 215 to the third party computer.

The third party computer lists (for example, in an electronic bulletin board, 207) the set of the transaction numbers that it has received from the N customers and that must be authorized, in the sense that the customers have not yet received a token which represents the certificate of validation for their transactions. The third party computer then creates an unique identifier for the list containing all the transaction numbers, and together with the list transaction numbers, the third party computer also lists on the bulletin board such unique identifier for that list of transactions. The third party computer also posts a note, stating that upon reception of N financial receipts associated to a total monetary amount equal to the sum of the prices listed on the bulletin board, the third party computer will authorize all the transactions listed on the bulletin board.

Each sending party computer sends to the third party computer the financial receipts (that is, the certificates of eligibility) and the unique identifier for the list of transactions (message 217), from the location from which the sending party computer sent the first message (in particular, it may be sent from the first email address account used for message 211), without the third party being able to recognize that messages 217 and 215 are originated from the same computer and sent by the same customer. Note that the sending party computer is not sending any reference to the specific transaction number that the customer wants to have validated. The sending party is only reporting the unique identifier for the list which includes the transaction that the customer wants to complete.

Upon receptions of N financial receipts sent together with the unique identifier for the list of transactions, and upon verification that the total of the amounts associated to the received financial receipts is equal to the sum of the prices in the list of transactions that the customers want to complete, the third party computer sends to all N connected computers certificate of validation associated with the specific transactions (message 219. Again, there will be N messages 219, but only one is reported in the Drawing) using the return addresses associated to messages 215 (for example, using the email address account from which each customer sent his message 215). The third party computer also transfers funds from his account to the merchant computers' accounts for the amount reported in the transactions' information sent by the customers, and using the merchants' contact information reported by the customers (flow of money 253, only one of N flows shown in the Drawing).

Each customer sends to the merchant computer from his computer the certificate of validation that it has received from the third party computer. The certificate of validation represents the proof that the customer has paid for the good or service to be sent or provided by the merchant computer (message 221).

Drawing 2 is a simplified entity/relationship diagram according to an exemplary Embodiment One of the present invention. The Drawing shows the various pieces of information that the various parties of a transaction can observe and store. The drawing shows that a customer can associate several pieces of information, but not so the third party and the merchant. In fact, the drawing also shows that third party cannot associate together the financial information (or the financial receipt) and the transaction information (or the receipt of validation).

Drawings 1 and 2 describe aspects of the invention illustrated by elements in simplified system and method diagrams. As will be understood by one of ordinary skill in the art, the elements can be implemented in computer software. The elements can also be implemented in computer hardware, or in non digital, non electronic systems (for example by using bank checks to transfer funds and the post service to exchange the messages). Alternatively, the elements can be implemented in a combination of computer hardware and software. Some of the elements may be integrated with other software and/or hardware. Some of the elements may be combined together or even separated. These and other variations, modifications, and alternatives will be apparent by one of ordinary skill in the art. Further details of methods according to embodiments of the present invention can be found throughout the present specification and more particularly below. It is also understood that the examples and embodiments described herein are for illustrative purposes only and that various modifications or changes in light thereof will be suggested to persons skilled in the art and are to be included within the spirit and purview of this application and scope of the appended claims.

What is claimed is:

1. A method for transfer of information between sending parties and receiving parties through one third party, the method allowing a third party to deem a sending party “eligible” to transfer information to receiving parties and to give said sending party a “certificate of eligibility;” the method also allowing the third party to deem the information to be transferred by a sending party to receiving parties “valid,” and to give said sending party a “certificate of validity;” in such a way that each receiving party upon reception of the information transferred by the sending party can verify that the party sending the information has been deemed eligible by the third party, and that the information received has also been deemed valid by the third party, but neither the third party nor any of the receiving parties are able to associate a specific certificate of eligibility corresponding to a sending party to a certificate of validity corresponding to the information being transferred by said sending party; the method comprising:
two or more sending parties each transferring a first message to a third party, each sending party transferring one such message;
each first message by a sending party being transferred from said sending party's first location, there preferably being as many first locations as sending parties;
each first location being any type of location from where information can be transferred (for example: a certain computer, or a certain Internet Protocol address, or a certain post office);
each first location possibly being known or recognizable by other parties;
there being preferably no connection between the sending parties, their first locations, and their first messages;
each first message including a first object and a second object;
a first object being information that the third party needs to verify in order to determine whether the sending party of the first message which includes said first object can be deemed eligible by the third party to transfer information to receiving parties;
a second object being return information that the third party uses to return an answer to the sending party at the first location of the sending party of a first message;
the third party receiving two or more first messages, one said message from each sending party;
the third party using the first object contained in each received first message to determine whether the sending party of said message can be deemed eligible by the third party to transfer information to receiving parties;
the eligibility of each sending party to send information to receiving parties being judged by the third party;
the third party creating none, one, or more third objects, one third object for each sending party that the third party has deemed eligible to transfer information to receiving parties;
each third object for each sending party deemed eligible being unique;
the third party maintaining correspondences, for all third objects, between the eligible sending party for which a third object was created and said third object;
a third object corresponding to a sending party being a certificate of eligibility stating that said sending party has been deemed eligible by the third party to transfer information to receiving parties;
the third party transferring none, zero, or more second messages, one second message to each sending party that the third party has deemed eligible to send information to receiving parties;
each second message containing the third object corresponding to the sending party to whom said second message is being transferred;
each second message therefore being unique;
the third party using the second object contained in a first message transferred by a sending party deemed eligible in order to transfer a second message to said sending party;
each sending party deemed eligible by the third party receiving a second message;
each sending party that receives a second message then transferring a third message to the third party;
each third message by a sending party being transferred from said sending party's second location;
each second location being any type of location from where information can be transferred (for example: a certain computer, or a certain Internet Protocol address, or a certain post office);
each second location potentially being known or recognizable by other parties;
the second location for a sending party being different from the first location for the same sending party;
the third party therefore not being able to associate a first message and a third message sent by the same party from the location alone;
the third party therefore not being able to associate the sending party of a first message and the sending party of a third message from the location alone;
each third message including a fourth object and a fifth object and a sixth object;
for each third message, a fourth object containing the information that a sending party wants to transfer to a receiving party;
for each third message, a fifth object being an identifier associated to the fourth object included in the same message;
for each third message, a sixth object being return information that allows the third party to return an answer to the sending party of the third message at the second location of the sending party of said message;
the sixth object being different from the second object for each sending party;
the third party receiving none, one, or more third messages;
the third party creating one seventh object;
the seventh object being a list of all the fifth objects associated to fourth objects included in all third messages the third party has received;
the third party transferring one fourth message to each sending party that transferred a first message;
the fourth message being the same for all sending parties;
the third party using the second object included in each received first message in order to send the fourth message to each sending party;
each sending party receiving the fourth message;
each sending party verifying whether said party's fifth object is listed in the third party's seventh object included in the fourth message;
none, one, or more sending parties finding their fifth object listed in the third party's seventh object included in the fourth message;
each sending party that found said party's fifth object listed in the third party's seventh object included in the fourth message, now transferring a fifth message to the third party;
each fifth message including for each sending party the third object that said sending party has received from the third party in the second message it has received;
each fifth message also including the seventh object;
the third party receiving none, one, or more fifth messages;
the third party verifying it has received an equal number of third and fifth messages;
the third party verifying that the number of third objects in all the fifth messages it has received equals the number of fifth objects listed in the seventh object it created;
upon positive verification that the third party has received an equal number of third and fifth messages and that the number of third objects in all the fifth messages the third party has received equals the number of fifth objects listed in the seventh object the third party created, the third party creating one or more eighth objects, one eighth object for each received third message;
the third party maintaining correspondences, for all eighth objects, between the fourth object included in a third message and associated to a fifth object that was listed in the seventh object for which an eighth object was created, and said eighth object;
each correspondence being such that it can be observed by any other party;
an eighth object corresponding to a fourth object being a certificate of validity stating that the information included in said fourth object has been deemed valid by the third party to be transferred to receiving parties;
each eighth object for each received third message therefore being unique;
the third party transferring one or more sixth messages, one sixth message to each sending party that transferred a third message containing a fourth object associated to a fifth object that was listed in the seventh object, and therefore including information that the third party has deemed valid to be transferred to receiving parties;
each sixth message containing the eighth object corresponding to the fourth object included in a third message and associated to a fifth object that was listed in the seventh object for which an eighth object was created;
each sixth message therefore being unique;
the third party using the sixth object contained in the third message by a sending party in order to transfer a sixth message to said sending party;
the third party therefore also not being able to associate a second object and a sixth object sent by the same sending party;
the third party therefore also not being able to associate a sending party to which it transferred the second message and a sending party to which it transferred the fifth message;
the third party therefore also not being able to associate a specific certificate of eligibility corresponding to a sending party to a certificate of validity corresponding to the information being transferred by said sending party;
one or more sending parties that sent a third message each receiving a sixth message;
each sending party after receiving a sixth message now creating a seventh message;
each seventh message including the fourth object the sending party had sent in the third message and the eighth object the sending party received in the sixth message;
each sending party transferring from any location except the first location the seventh message to a receiving party;
each receiving party receiving the seventh message;
each receiving party being able to observe the correspondence between the fourth object and the eighth object included in a seventh message;
each receiving party therefore being able to recognize that the information the sending party wants to transfer to the receiving party has been deemed valid by the third party;
each receiving party therefore being also able to conclude that the sending party that sent the seventh message has been deemed eligible to transfer information to receiving parties by the third party;
no receiving party being able to associate the eighth object or the fourth object to the second object for the same sending party;
no receiving party therefore being able to associate a first location from which the sending party has sent the first messages and the additional second location from which the same said sending party has sent the seventh message;
no receiving party therefore being able to associate a specific certificate of eligibility corresponding to a sending party to a certificate of validity corresponding to the information being transferred by the same said sending party.

2. The method of claim 1, wherein the correspondence between a fourth object and a fifth is the hash according to a known function of the fourth object; and the correspondence between the eight object and the fourth object is the hash of the fourth object added to the certificate of validity created by the third party.

3. The method of claim 1, wherein public-private key encryption is used to protect the messages that are sent among the various parties, and where in particular the third party uses his private key to sign the certificates of validation and eligibility, and the sending parties use multiple public keys which they pass to the third party in their first and third messages, and the multiple public keys of the sending parties are used by the third party to encrypt the certificates of validation and eligibility and to associate them to each sending party, so that no other party can use them except the party for which they have been created.

4. A method for transfer of information between sending parties and receiving parties through one third party that enables the eligibility of some sending parties to send certain messages to some receiving parties to be verified by a third party, and enables the third party to verify the validity of the messages, and then enables the sending parties to send each a message to one or more receiving parties, in such a way that each receiving party knows that the eligibility of the sender or senders of the message or messages that the receiving party has received has been verified by the third party and that the validity of the message or messages has been also verified by the third party, but neither the third party nor any of the receiving parties are able to associate a specific message to the sending party that has sent that message; the method comprising:
the sending parties are numbered 1 to N and the receiving parties are numbered 1 to M;
each sending party sends a first message to a third party containing information that the third party needs to know to verify the eligibility of the third party to send a message to one or many of the receiving parties, and a return information that the third party needs to know in order to reply to each sender of such first message, such as a return address. The information that the third party need to know in order to verify the eligibility of the sending party could for example include the real identity of the sending party;
the third party verifies the eligibility of each sending party to send a message to one or more receiving parties, where the eligibility depends on the context in which the method is used, and for each sending party which is deemed eligible, the third party uses the information included in the first message sent by that sending party in order to send to such sending party a second message, containing a unique receipt of eligibility that proves that the sending party is eligible to send a message to the receiving party or parties, where the receipt of eligibility is a message that shows that the sender has been deemed eligible by the third party to send out a message, and each receipt of eligibility is unique and is not repeated for any other sending party, and is associated to the return information included in the first message in the sense that every other party could recognize that a certain receipt of eligibility has been created for a certain return information (for example, because the receipt of eligibility could also include the return information);
parties 1 to N send each a third message to the third party, each third message containing the final message that the sending parties want to send anonymously to the receiving party or parties, and a new return information that allows the third party to contact each sender of the third message, where the return information contained in each third message is different from the return information contained in each first message and has no association or link with it, so that the third party is not able to associate the first and third messages originated from the same sending party, and therefore the third party is not able to associate the receipt of eligibility that it has created to the final message that each sending party wants to send to a receiving party and that is contained in the third message. For example, the first and third messages of a same sending party could be sent by postal mail, posted from different locations, and reporting different return addresses;
the third party selects T of the N third messages that it has received, where T is less or equal to N, and compiles a list of these T messages and associates each of those messages to an unique identifier created for the list, and then sends to all N parties a fourth message using the return information contained in the N first messages that it has received, the fourth message containing a list with the T third messages that the third party has selected and the unique identifier for the list;
parties 1 to N receive the fourth message, and each of the T parties that finds that its third message is contained in the list whose unique identifier is reported inside the fourth message, replies to the third party by sending a fifth message, each fifth message containing the unique receipt of eligibility that the party has received from the third party with the second message and also containing the unique identifier for the list, but each fifth message not containing any return information that would allow the third party to contact each sender of the fifth message or to associate him to the senders of the previous messages, so that the third party is not able to link the first and third and fifth messages originated from the same sending party, and therefore cannot associate the receipt of eligibility to the final message contained in the third message that each sending party wants to send to a receiving party or parties;
the third party, upon receiving exactly T fifth messages each containing a unique receipt of eligibility and the unique identifier for the list containing the T third messages that it has selected, creates T receipts of validation for the T selected messages, where each receipt of validation is a message that shows that the third message has been deemed valid by the third party, and each receipt of validation is unique and is not repeated for any other sending party, and is associated to the third message in a way that every other party could recognize that a certain receipt of validation has been created for a certain third message (for example because the receipt of validation also contains a certain third message), and then the third party sends the unique receipts of validation to T parties in a sixth message, using the return information contained in each of the T selected third messages. If the third party does not receive exactly T unique receipts of eligibility, the third party selects a new set of T third messages and repeats the method from the point where it sends the fourth messages to the new T parties that it has selected;
upon reception of the receipts of validation, each sending party creates a seventh message, each seventh message containing the third message, which in turns contains the final message that the sending party wants to send to the receiver, and also containing the receipts of validation associated to that third message that the sending party has received from the third party inside the sixth message, and sends this seventh message to the receiver party, which is one or more of 1 . . . M.

5. The method of claim 4, wherein the third party, after selecting T of the N third messages but before sending its fourth message, selects the remaining N-T messages (if T is less than N) and compiles another list containing such N-T messages, and creates another unique identifier for this new list, and associates each of such N-T messages to this new unique identifier, and then sends the fourth message to all N parties, the fourth message now containing the two lists with the T and N-T third messages that the third party has selected and the unique identifiers for each of the lists, and then each sending party includes in his fifth message the unique identifier that he sees associated to the list that contains his third message.

5. The method of claim 4, wherein after the third party has sent the second message to the N sending parties, and before the N parties send each their third message, one of the N sending parties broadcasts an eight message, broadcasts meaning that it sends the message in a way that all other N parties and the third party can receive it, the message containing a return information to contact the sending party of the eight message, and an invitation to other parties to reply to the sending party of the eight message by sending a ninth message, in which the eight message is copied and return information to contact each of the senders of each ninth message is contained, and then some or all of the parties receiving the eight message send such ninth message to the party that sent the eight message using the return information contained in the eight message, and then the sending party of the eight message, upon reception of N or less than N ninth messages, selects R of them, with R larger than 0 and equal or less to N, and sends to R such parties and to the third party a tenth message using the return information that the R parties have included in their ninth messages, the tenth message containing the number R and an unique identifier which is the same for all R parties, after which the R selected parties send an eleventh message to the third party, where the eleventh message is the same as the third message in claim 6 but now also contains the unique identifier that they have received in the tenth message, and upon reception of R of such messages the third party selects the R sending parties as the T parties to which it will send the fourth message, after which the method proceeds as in claim 4.

6. The method of claim 4, wherein upon reception of the sixth message, one, some or all of the sending parties do not prepare the seventh message for the receiving party but rather prepare a twelfth message, the twelfth message being equivalent to the third message but containing in place of the receipt of eligibility the receipt of validation that each sending party has received from the third party with the sixth message, from which point the method proceeds as in claim 4, with the parties writing thirteenth, fourteenth, fifteenth and sixteenth messages equivalent to the fourth, fifth, and sixth messages in claim 4, where a new receipt of validation is created by the third party for each of the sending parties that has decided to send such twelfth message, and each such new receipt of validation is sent by the third party in a fifteenth message to each of the parties which sent the twelfth message, and each of the sending party who receives the fifteenth message sends the new receipt of validation to the receiving party or parties of the final message in the sixteenth message.

7. The method of claim 4, wherein where all the steps of the method are repeated again and the receipts are valid for one transaction only, where one transaction is considered to be the set of steps considered in claim 4, and all sending, receiving and third parties are able to recognize whether a receipt of validation or eligibility has been used in previous transactions, because those receipts are broadcasted publicly by the third party at the end of each transaction.
